(19) United States
(12) Patent Application Publication
(10) Pub. No.: US 2022/0338006 A1
(43) Pub. Date: Oct. 20, 2022

(54) WIRELESS COMMUNICATION DEVICE, NON-TRANSITORY COMPUTER READABLE STORAGE MEDIUM, AND SYSTEM

(71) Applicant: KABUSHIKI KAISHA TOKAI RIKA DENKI SEISAKUSHO, Aichi (JP)

(72) Inventors: Yosuke HASEGAWA, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/697,340

(22) Filed: Mar. 17, 2022

(30) Foreign Application Priority Data
Apr. 16, 2021 (JP) 2021-069846

(51) Int. Cl. H04W 12/06; H04L 1/18

(52) U.S. Cl. CPC H04W 12/06; H04L 1/1816

(57) ABSTRACT

There is provided a wireless communication device comprising: a first wireless communication unit configured to transmit and receive a wireless signal compliant with a first communication standard to and from another wireless communication device; a second wireless communication unit configured to transmit and receive a wireless signal compliant with a second communication standard to and from the other wireless communication device; and a control unit configured to control transmission and reception of wireless signals, wherein, in a case where the first wireless communication unit is caused to transmit an authentication request and then the first wireless communication unit is not able to receive an authentication response from the other wireless communication device within a specified time, the control unit causes the first wireless communication unit to retransmit the authentication request after transmission and reception of the wireless signal compliant with the second communication standard are completed.

### CROSS REFERENCE TO RELATED APPLICATION(S)

This application is based upon and claims benefit of priority from Japanese Patent Application No. 2021-069846, filed on Apr. 16, 2021, the entire contents of which are incorporated herein by reference.

### BACKGROUND

The present invention relates to a wireless communication device, a non-transitory computer readable storage medium, and a system.

In recent years, a technique of performing authentication in accordance with the result of transmitting and receiving signals between devices has been developed. For example, JP H11-208419A discloses a system in which a vehicle-mounted device authenticates a portable device by transmitting and receiving a signal to and from the portable device.

### SUMMARY

In the above system, in order to improve security, a multi-stage mechanism of authentication is also envisaged. However, in this case, executions of a plurality of different processes overlapping each other are likely to influence any of the processes.

Consequently, the present invention was contrived in view of the above problem, and an object of the present invention is to attain both an improvement in security and the accomplishment of a series of processes.

To solve the above described problem, according to an aspect of the present invention, there is provided a wireless communication device comprising: a first wireless communication unit configured to transmit and receive a wireless signal compliant with a first communication standard to and from another wireless communication device different from the wireless communication device; a second wireless communication unit configured to transmit and receive a wireless signal compliant with a second communication standard different from the first communication standard to and from the other wireless communication device; and a control unit configured to control transmission and reception of wireless signals performed by the first wireless communication unit and the second wireless communication unit, wherein, in a case where the first wireless communication unit is caused to transmit an authentication request used for authentication of the other wireless communication unit and then the first wireless communication unit is not able to receive an authentication response as a response to the authentication request from the other wireless communication device within a specified time, the control unit causes the first wireless communication unit to retransmit the authentication request after transmission and reception of the wireless signal compliant with the second communication standard between the second wireless communication unit and the other wireless communication device are completed.

To solve the above described problem, according to another aspect of the present invention, there is provided a non-transitory computer readable storage medium having a program stored therein, the program causing a computer to realize a control function of controlling a first wireless communication unit configured to transmit and receive a wireless signal compliant with a first communication standard to and from another wireless communication device and a second wireless communication unit configured to transmit and receive a wireless signal compliant with a second communication standard different from the first communication standard to and from the other wireless communication device, wherein, in a case where the first wireless communication unit is caused to transmit an authentication request used for authentication of the other wireless communication unit and then the first wireless communication unit is not able to receive an authentication response as a response to the authentication request from the other wireless communication device within a specified time, the control function causes the first wireless communication unit to retransmit the authentication request after transmission and reception of the wireless signal compliant with the second communication standard between the second wireless communication unit and the other wireless communication device are completed.

To solve the above described problem, according to another aspect of the present invention, there is provided a system comprising: a first wireless communication device; and a second wireless communication device, wherein the first wireless communication device includes a first wireless communication unit configured to transmit and receive a wireless signal compliant with a first communication standard to and from the second wireless communication device, a second wireless communication unit configured to transmit and receive a wireless signal compliant with a second communication standard different from the first communication standard to and from the second wireless communication device, and a control unit configured to control transmission and reception of wireless signals of the first wireless communication unit and the second wireless communication unit, and wherein, in a case where the first wireless communication unit is caused to transmit an authentication request used for authentication of the second wireless communication unit and then the first wireless communication unit is not able to receive an authentication response as a response to the authentication request from the second wireless communication device within a specified time, the control unit causes the first wireless communication unit to retransmit the authentication request after transmission and reception of the wireless signal compliant with the second communication standard between the second wireless communication unit and the second wireless communication device are completed.

According to the present invention as described above, it is possible to attain both an improvement in security and the accomplishment of a series of processes.

### BRIEF DESCRIPTION OF THE DRAWINGS

FIG. 1 is a block diagram illustrating a configuration example of a system 1 according to an embodiment of the present invention.

FIG. 2 is a sequence diagram illustrating an example of a flow of authentication based on a wireless signal compliant with a first communication standard according to the embodiment and specified processing based on a wireless signal compliant with a second communication standard.

FIG. 3 is a sequence diagram illustrating an example of a flow of retransmission control of an authentication request according to the embodiment.

FIG. 4 is a flowchart illustrating an example of a flow of control performed by a control unit 130 of a vehicle-mounted device 10 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. System Configuration Example

First, a configuration example of a system 1 according to an embodiment of the present invention will be described.

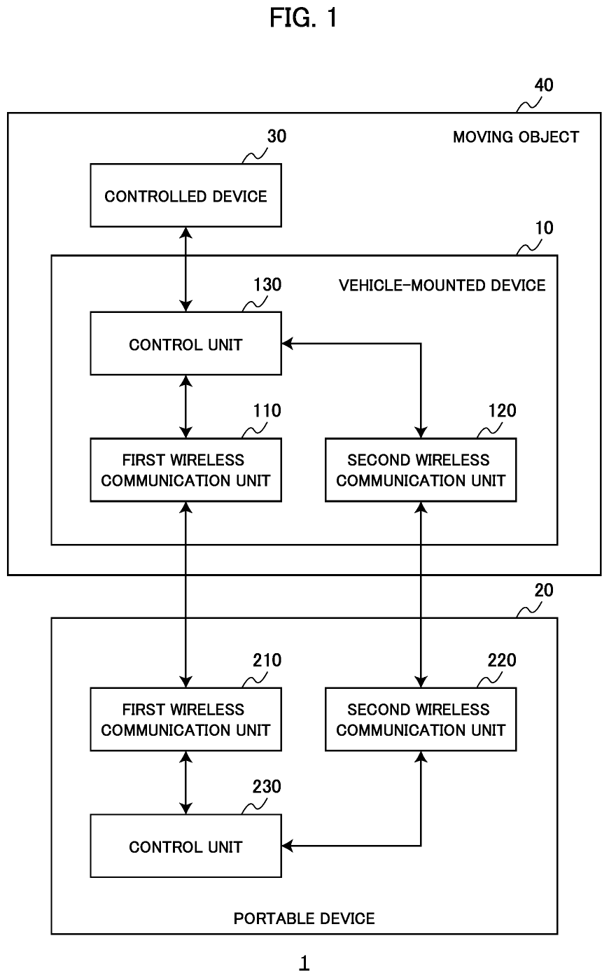

FIG. 1 is a block diagram illustrating a configuration example of the system 1 according to an embodiment of the present invention.

In the case of the example shown in FIG. 1, the system 1 according to the present embodiment includes a vehicle-mounted device 10 and a controlled device 30 which are mounted in a moving object 40 such as a vehicle and a portable device 20.

### (Vehicle-Mounted Device 10)

The vehicle-mounted device 10 according to the present embodiment is an example of a wireless communication device mounted in the moving object 40 to perform wireless communication with another wireless communication device (the portable device 20).

As shown in FIG. 1, the vehicle-mounted device 10 according to the present embodiment may include a first wireless communication unit 110, a second wireless communication unit 120, and a control unit 130.

### (First Wireless Communication Unit 110)

The first wireless communication unit 110 according to the present embodiment transmits and receives a wireless signal compliant with a first wireless communication standard to and from the portable device 20 carried by a user who uses the moving object 40 in which the vehicle-mounted device 10 is mounted (for example, an owner of the moving object 40 or a person who is permitted to use the moving object 40 by the owner).

For example, a signal in a low frequency (LF) band and a signal in an ultra-high frequency (UHF) band may be used in the first wireless communication standard.

The first wireless communication unit 110 includes an antenna element for transmitting and receiving a wireless signal compliant with the first wireless communication standard.

In addition, the first wireless communication unit 110 according to the present embodiment may authenticate the portable device 20 on the basis of the transmitted and received wireless signal.

As an example, the first wireless communication unit 110 according to the present embodiment transmits an authentication request to the portable device 20 in accordance with control performed by the control unit 130, and receives an authentication response which is transmitted by the portable device 20 as a response to the authentication request.

In this case, the authentication request may be a signal for requesting information required for authentication relating to the authenticity of the portable device 20, and the authentication request may be a signal including information required for authentication.

Meanwhile, examples of the information required for the authentication include an identifier of the portable device 20, a password determined in advance, key information, a result of calculation using a hash function, and the like.

The first wireless communication unit 110 transmits the result of authentication to the control unit 130.

On the other hand, authentication based on the authentication request and the authentication response may be executed by the control unit 130.

### (Second Wireless Communication Unit 120)

The second wireless communication unit 120 according to the present embodiment transmits and receives a wireless signal compliant with a second wireless communication standard different from the first wireless communication standard to and from the portable device 20.

An example of the second wireless communication standard is ultra-wide band (UWB) wireless communication.

On the other hand, the second wireless communication standard according to the present embodiment is not limited to the above example, and may be any of various standards that can be used to execute specified processing to be described later.

The second wireless communication unit 120 includes an antenna element for transmitting and receiving a wireless signal compliant with the second wireless communication standard.

In addition, the second wireless communication unit 120 according to the present embodiment may execute specified processing using the transmitted and received wireless signal.

The specified processing may be, for example, processing of estimating a positional relationship between the vehicle-mounted device 10 and the portable device 20 (more accurately, a positional relationship between the second wireless communication unit 120 and a second wireless communication unit 220 provided in the portable device 20).

Examples of the processing of estimating the positional relationship include processing of estimating a distance between the vehicle-mounted device 10 and the portable device 20 (hereinafter also referred to as distance measurement) and processing of estimating the angle of the portable device 20 with the vehicle-mounted device 10 as a starting point.

In addition, the second wireless communication unit 120 transmits the result of the specified processing to the control unit 130.

### (Control Unit 130)

The control unit 130 according to the present embodiment controls the transmission and reception of wireless signals performed by the first wireless communication unit 110 and the second wireless communication unit 120.

In addition, the control unit 130 according to the present embodiment controls the operation of the controlled device 30 mounted in the moving object 40 on the basis of the result of authentication using a wireless signal compliant with the first communication standard and the result of specified processing using a wireless signal compliant with the second communication standard.

For example, in a case where the authenticity of the portable device 20 is recognized on the basis of the authentication response and the specified processing is within a specified range, the control unit 130 according to the present embodiment may cause the controlled device 30 to execute a specified operation.

For example, in a case where the specified processing is processing of estimating the above-described positional relationship, the authenticity of the portable device 20 is recognized, and it is estimated that the vehicle-mounted device 10 and the portable device 20 are in a specified positional relationship, the control unit 130 may cause the controlled device 30 to execute a specified operation.

In addition, for example, in a case where the specified processing is the above-described distance measurement, the authenticity of the portable device 20 is recognized, and the estimation value of a distance between the vehicle-mounted device 10 and the portable device 20, that is, the distance measurement value obtained by the distance measurement, is estimated to be in a specified range, the control unit 130 may cause the controlled device 30 to execute a specified operation.

Meanwhile, the controlled device 30 according to the present embodiment may be any of various devices mounted in the moving object 40.

The controlled device 30 according to the present embodiment may be, for example, a locking device that controls unlocking and locking of the door of the moving object 40, an engine, or the like.

For example, in a case where the authenticity of the portable device 20 is recognized and the result of the specified processing satisfies specified conditions, the control unit 130 may cause the locking device to execute unlocking of the door or start the engine.

The function of the control unit 130 according to the present embodiment is realized by various processors.

### (Portable Device 20)

The portable device 20 according to the present embodiment is an example of a wireless communication device which is carried by a user who uses the moving object 40 to perform wireless communication with the vehicle-mounted device 10 mounted in the moving object 40.

As shown in FIG. 1, the portable device 20 according to the present embodiment may include a first wireless communication unit 210, the second wireless communication unit 220, and a control unit 230.

### (First Wireless Communication Unit 210)

The first wireless communication unit 210 according to the present embodiment transmits and receives a wireless signal compliant with the first wireless communication standard to and from the vehicle-mounted device 10 mounted in the moving object 40.

For this purpose, the first wireless communication unit 210 according to the present embodiment includes an antenna element capable of transmitting and receiving a wireless signal compliant with the first wireless communication standard. A case where the first wireless communication unit 110 of the vehicle-mounted device 10 transmits an authentication request and the first wireless communication unit 210 of the portable device 20 transmits an authentication response as a response to the authentication request has been given as an example above.

On the other hand, in a case where the portable device 20 authenticates the vehicle-mounted device 10, the authentication request may be transmitted by the first wireless communication unit 210 of the portable device 20. In this case, the first wireless communication unit 110 of the vehicle-mounted device 10 transmits an authentication response as a response to the received authentication request.

### (Second Wireless Communication Unit 220)

The second wireless communication unit 220 according to the present embodiment transmits and receives a wireless signal compliant with the second wireless communication standard to and from the vehicle-mounted device 10 mounted in the moving object 40.

For this purpose, the second wireless communication unit 220 according to the present embodiment includes an antenna element capable of transmitting and receiving a wireless signal compliant with the second wireless communication standard.

In addition, the second wireless communication unit 220 according to the present embodiment may execute specified processing on the basis of the transmitted and received wireless signal.

### (Control Unit 230)

The control unit 230 according to the present embodiment controls the transmission and reception of wireless signals performed by the first wireless communication unit 210 and the second wireless communication unit 220.

The function of the control unit 130 according to the present embodiment is realized by various processors.

Heretofore, a configuration example of the system 1 according to the present embodiment has been described above. Meanwhile, the above configuration described with reference to FIG. 1 is merely an example, and the configuration of the system 1 according to the present embodiment is not limited to such an example.

For example, the vehicle-mounted device 10 may include a plurality of second wireless communication units 120. In this case, each of the plurality of second wireless communication units 120 may transmit and receive wireless communication to and from the portable device 20 and execute specified processing.

### 1.2. Details

Next, processing performed by the system 1 according to the present embodiment will be described in detail.

Here, first, the flow of processing in a case where the authentication based on a wireless signal compliant with the first communication standard and the specified processing based on a wireless signal compliant with the second communication standard are executed will be described.

Meanwhile, a case where the above-described specified processing is distance measurement will be illustrated below.

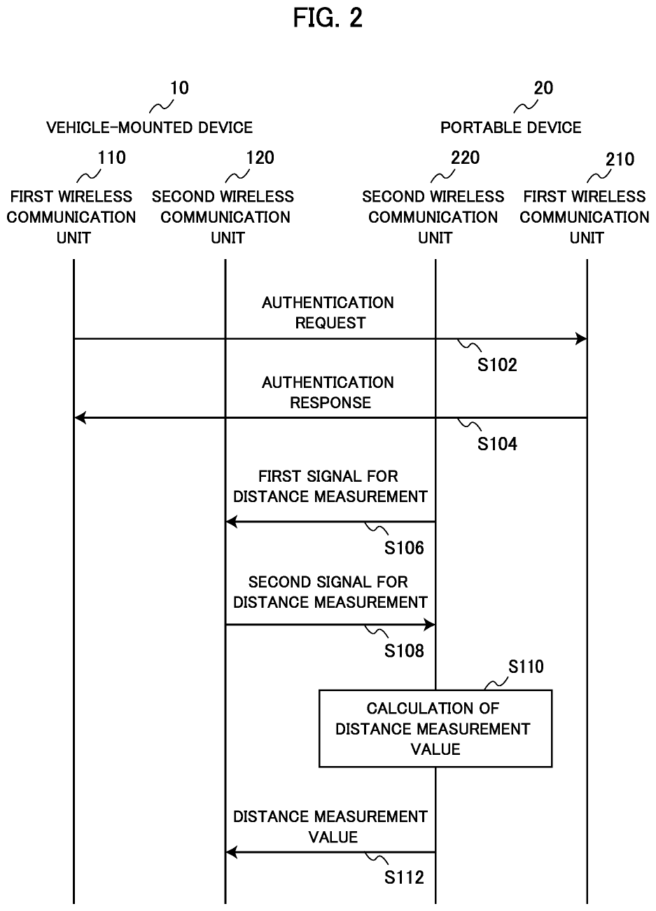

FIG. 2 is a sequence diagram illustrating an example of a flow of authentication based on the wireless signal compliant with the first communication standard according to the present embodiment and specified processing based on the wireless signal compliant with the second communication standard.

In the case of the example shown in FIG. 2, first, the control unit 130 of the vehicle-mounted device 10 causes the first wireless communication unit 110 to transmit an authentication request (S102).

The control unit 230 of the portable device 20 causes the first wireless communication unit 210 to transmit an authentication response as a response to the authentication request on the basis of the first wireless communication unit 210 receiving the authentication request in step S102 (S104).

In step S104, in a case where the first wireless communication unit 110 of the vehicle-mounted device 10 receives the authentication response, the first wireless communication unit 110 or the control unit 130 authenticates the portable device 20 on the basis of the authentication response (not shown).

On the other hand, the control unit 230 of the portable device 20 causes the first wireless communication unit 210 to transmit the authentication response in step S104, and then causes the second wireless communication unit 220 to transmit a first signal for distance measurement used for distance measurement (S106).

In step S106, in a case where the second wireless communication unit 120 of the vehicle-mounted device 10 receives the first signal for distance measurement, the control unit 130 causes the second wireless communication unit 120 to transmit a second signal for distance measurement in response to the first signal for distance measurement (S108).

Next, the second wireless communication unit 220 of the portable device 20 calculates the distance measurement value on the basis of the first signal for distance measurement transmitted in step S106 and the second signal for distance measurement received in step S108 (S110).

In this way, the distance measurement according to the present embodiment may include the transmission and reception of the first signal for distance measurement and the second signal for distance measurement and the calculation of the distance measurement value based on both signals.

The second wireless communication unit 220 of the portable device 20 can calculate the distance measurement value on the basis of a time ΔT1 from a time at which the first signal for distance measurement is transmitted to a time at which the second signal for distance measurement is received and a time ΔT2 from a time at which the second wireless communication unit 120 of the vehicle-mounted device 10 receives the first signal for distance measurement to a time at which the second signal for distance measurement is transmitted.

More specifically, the second wireless communication unit 220 of the portable device 20 can calculate a time for propagation of the first signal for distance measurement and the second signal for distance measurement (that is, a time required for round trip communication) by subtracting the time ΔT2 from the time ΔT1, and can calculate a time required for propagation of either the first signal for distance measurement or the second signal for distance measurement (that is, a time required for one-way communication) by dividing the time by two.

Further, the second wireless communication unit 220 can calculate the distance measurement value by multiplying the value of (time ΔT1−time ΔT2)/2 by the speed of the signal.

The second wireless communication unit 220 of the portable device 20 transmits the distance measurement value calculated as described above to the second wireless communication unit 120 of the vehicle-mounted device 10 (S112).

The control unit 130 of the vehicle-mounted device 10 controls the operation of the controlled device 30 on the basis of the result of authentication based on the distance measurement response received by the first wireless communication unit 110 in step S104 and the distance measurement value received by the second wireless communication unit 120 in step S112.

Heretofore, a flow of the authentication based on the wireless signal compliant with the first communication standard according to the present embodiment and the specified processing based on the wireless signal compliant with the second communication standard has been described with an example.

Meanwhile, in the above description using FIG. 2, an example of the case where the first signal for distance measurement is transmitted by the second wireless communication unit 220 of the portable device 20 and the second signal for distance measurement is transmitted by the second wireless communication unit 120 of the vehicle-mounted device 10 has been described.

On the other hand, the first signal for distance measurement may be transmitted by the second wireless communication unit 120 of the vehicle-mounted device 10, and the second signal for distance measurement may be transmitted by the second wireless communication unit 220 of the portable device 20.

In addition, similarly, the calculation of the distance measurement value may be executed by either the second wireless communication unit 120 of the vehicle-mounted device 10 or the second wireless communication unit 220 of the portable device 20.

The calculation of the distance measurement value can be executed by either the second wireless communication unit 120 or the second wireless communication unit 220 by transmitting and receiving information relating to the time ΔT1 and the time ΔT2 described above.

Further, the transmission and reception of the first signal for distance measurement and the second signal for distance measurement and the calculation of the distance measurement value may be executed multiple times.

The flow of the distance measurement processing according to the present embodiment can be flexibly modified.

Next, retransmission control of the authentication request according to the present embodiment will be described.

In the above description using FIG. 2, an example of the case where the first wireless communication unit 110 of the vehicle-mounted device 10 transmits the authentication request and normally receives the authentication response from the portable device 20 as a response to the authentication request has been described.

However, it is also assumed that the authentication request or the authentication response is not normally received by the other party's device due to the influence of noise or the like.

In such a case, the control unit 130 of the vehicle-mounted device 10 may attempt to retry the authentication by causing the first wireless communication unit 110 to retransmit the authentication request.

However, in this case, when the authentication request or the authentication response is retransmitted at a timing at which the first signal for distance measurement or the second signal for distance measurement is transmitted and received, the possibility of the wireless signal compliant with the first communication standard and the wireless signal compliant with the second wireless signal interfering with each other cannot be ruled out.

In addition, depending on the specification of a processor or the like, it may be difficult to perform parallel processing between authentication and distance measurement.

Therefore, one characteristic is that, in a case where the first wireless communication unit 110 is caused to transmit the authentication request and then the first wireless communication unit 110 is not able to receive the authentication response as a response to the authentication request from the portable device 20 within a specified time, the control unit 130 of the vehicle-mounted device 10 according to the present embodiment causes the first wireless communication unit 110 to retransmit the authentication request after the transmission and reception of the wireless signal compliant with the second communication standard between the second wireless communication unit 120 and the portable device 20 are completed.

According to the control as described above, it is possible to prevent the interference between the wireless signal compliant with the first communication standard and the wireless signal compliant with the second communication standard.

In addition, in a case where the first wireless communication unit 110 is not able to receive the authentication response within a specified time, the control unit 130 of the vehicle-mounted device 10 according to the present embodiment may cause the first wireless communication unit 110 to retransmit the authentication request after the specified processing using the wireless signal compliant with the second communication standard is completed.

According to the control as described above, it is possible to more reliably accomplish a series of processes by starting to retry the authentication after the specified processing is normally completed.

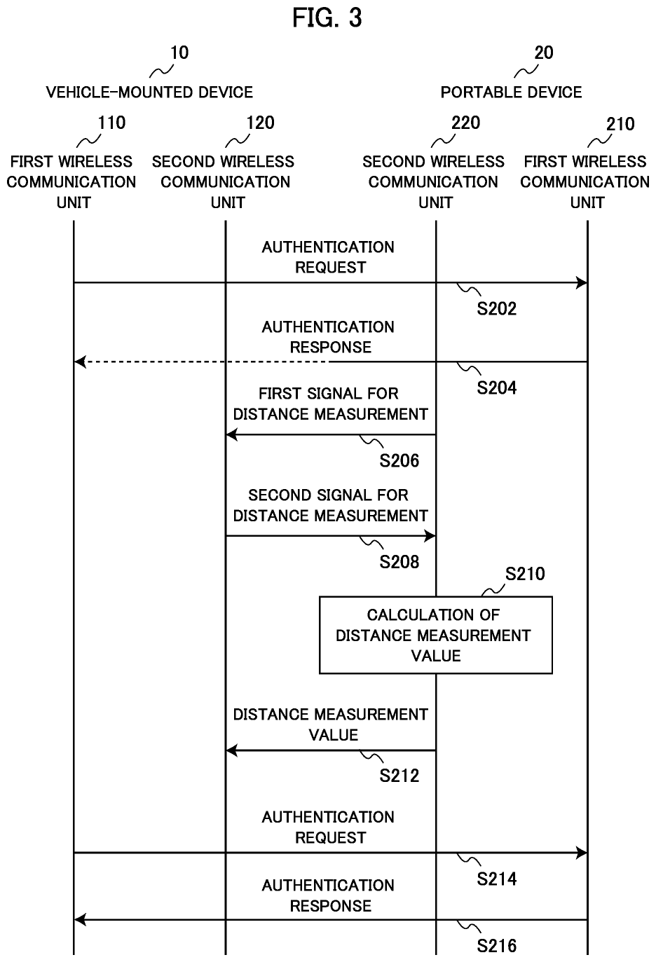

FIG. 3 is a sequence diagram illustrating an example of a flow of retransmission control of the authentication request according to the present embodiment.

Each process in steps S202 to S212 shown in FIG. 3 may be substantially the same as each process in S102 to S112 shown in FIG. 2, and thus the detailed description thereof will be omitted.

However, in step S204 shown in FIG. 3, it is assumed that the first wireless communication unit 110 of the vehicle-mounted device 10 cannot normally receive the authentication response transmitted by the first wireless communication unit 210 of the portable device 20.

In this case, the control unit 130 of the vehicle-mounted device 10 according to the present embodiment causes the first wireless communication unit 110 to retransmit the authentication request after the transmission and reception of the first signal for distance measurement in step S206, the transmission and reception of the second signal for distance measurement in step S208, the calculation of the distance measurement value in step S210, and the transmission and reception of the distance measurement value in step S212 are completed (S214).

At this time, the control unit 130 of the vehicle-mounted device 10 may control the execution of retransmission of the authentication request on the basis of the second wireless communication unit 120 receiving the distance measurement value in step S212.

On the other hand, the control unit 130 of the vehicle-mounted device 10 may control the execution of retransmission of the authentication request on the basis of the elapse of time required for the distance measurement measured in advance.

The control unit 230 of the portable device 20 causes the first wireless communication unit 210 to transmit the authentication response on the basis of the first wireless communication unit 210 receiving the authentication request retransmitted in step S214. (S216).

In this case, the control unit 130 of the vehicle-mounted device 10 can control the operation of the controlled device 30 on the basis of the result of authentication based on the authentication response received by the first wireless communication unit 110 in step S216.

In addition, in a case where the first wireless communication unit 110 is caused to retransmit the authentication request as described above, the control unit 130 of the vehicle-mounted device 10 according to the present embodiment may perform control so that specified processing such as distance measurement is not re-executed.

That is, the control unit 130 of the vehicle-mounted device 10 according to the present embodiment may perform control so that the transmission and reception of the first signal for distance measurement, the transmission and reception of the second signal for distance measurement, and the calculation of the distance measurement value are not re-executed.

Meanwhile, as shown in FIG. 3, in a case where the first signal for distance measurement is transmitted by the second wireless communication unit 220 of the portable device 20, the vehicle-mounted device 10 may cause, for example, the first wireless communication unit 110 to transmit an authentication request including an instruction not to execute the retransmission of the first signal for distance measurement.

In addition, in such a case, the control unit 130 of the vehicle-mounted device 10 according to the present embodiment may control the operation of the controlled device 30 on the basis of the result of the specified processing obtained before the first wireless communication unit 110 is caused to retransmit the authentication request.

In the case of the example shown in FIG. 3, the control unit 130 of the vehicle-mounted device 10 may control the operation of the controlled device 30 on the basis of the distance measurement value calculated in step S210.

According to the control as described above, it is possible to effectively reduce time required for the entire processing as compared with a case where the specified processing is retried together with retrial of authentication.

Next, the flow of control performed by the control unit 130 of the vehicle-mounted device 10 will be described in more detail.

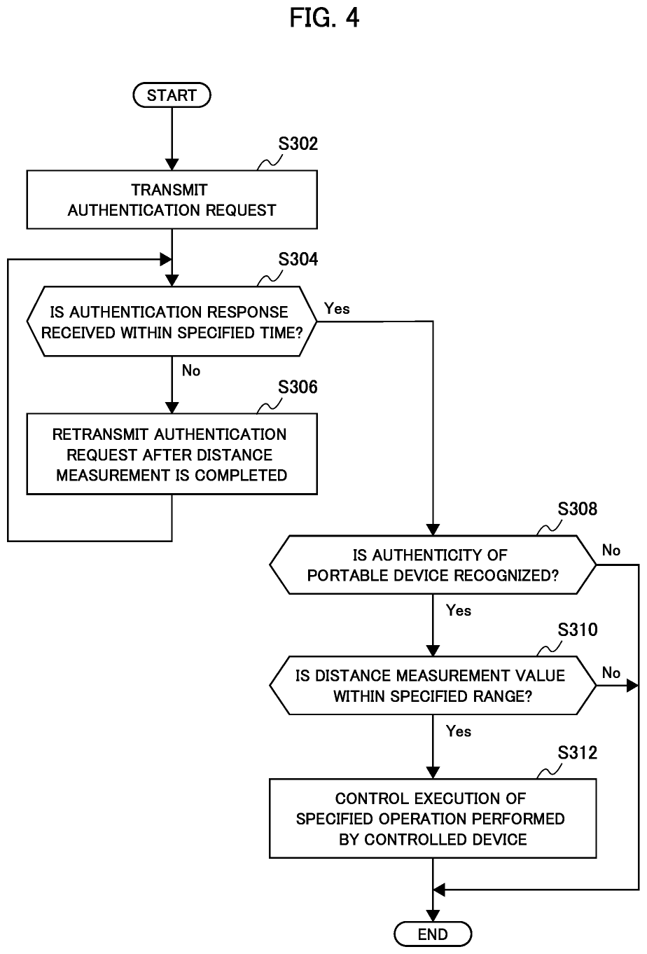

FIG. 4 is a flowchart illustrating an example of a flow of control performed by the control unit 130 of the vehicle-mounted device 10 according to the present embodiment.

Meanwhile, FIG. 4 shows an example of control in a case where the specified processing based on the wireless signal compliant with the second communication standard is distance measurement.

In the case of the example shown in FIG. 4, the control unit 130 first causes the first wireless communication unit 110 to transmit the authentication request (S302).

Next, the control unit 130 determines whether the first wireless communication unit 110 has received the authentication response within a specified time (S304).

In a case where the first wireless communication unit 110 has not received the authentication response within a specified time (S304: No), the control unit 130 causes the first wireless communication unit 110 to retransmit the authentication request after the distance measurement is completed (S306), and the process returns to step S304.

On the other hand, in a case where the first wireless communication unit 110 has received the authentication response within a specified time (S304: Yes), the control unit 130 determines whether the authenticity of the portable device 20 is recognized on the basis of the received authentication response (S308).

Here, in a case where the authenticity of the portable device 20 is not recognized on the basis of the authentication response (S308: No), the control unit 130 may end a series of processes.

Alternatively, the control unit 130 may transition to step S306 and cause the first wireless communication unit 110 to retransmit the authentication request.

On the other hand, in a case where the authenticity of the portable device 20 is recognized on the basis of the authentication request (S308: Yes), the control unit 130 determines whether the distance measurement value is within a specified range (S310).

Here, in a case where the distance measurement value is not within the specified range (S310: No), the control unit 130 may end a series of processes.

On the other hand, in a case where the distance measurement value is within the specified range (S310: Yes), the control unit 130 performs control so that a specified operation performed by the controlled device 30 is executed (S312).

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

In addition, a series of processes performed by each device described in the present specification may be realized by a program stored in a non-transitory computer readable storage medium. Each program is read, for example, into a RAM during computer execution and is executed by a processor such as a CPU. The above storage medium is, for example, a magnetic disc, an optical disc, a magneto-optic disc, a flash memory, or the like. In addition, the above program may be distributed, for example, through a network without using a storage medium.

What is claimed is:

1. A wireless communication device comprising:
a first wireless communication unit configured to transmit and receive a wireless signal compliant with a first communication standard to and from another wireless communication device different from the wireless communication device;
a second wireless communication unit configured to transmit and receive a wireless signal compliant with a second communication standard different from the first communication standard to and from the other wireless communication device; and
a control unit configured to control transmission and reception of wireless signals performed by the first wireless communication unit and the second wireless communication unit,
wherein, in a case where the first wireless communication unit is caused to transmit an authentication request used for authentication of the other wireless communication unit and then the first wireless communication unit is not able to receive an authentication response as a response to the authentication request from the other wireless communication device within a specified time, the control unit causes the first wireless communication unit to retransmit the authentication request after transmission and reception of the wireless signal compliant with the second communication standard between the second wireless communication unit and the other wireless communication device are completed.

2. The wireless communication device according to claim 1, wherein, in a case where the first wireless communication unit is not able to receive the authentication response within a specified time, the control unit causes the first wireless communication unit to retransmit the authentication request, after specified processing using the wireless signal compliant with the second communication standard is completed.

3. The wireless communication device according to claim 2, wherein, in a case where the first wireless communication unit is caused to retransmit the authentication request, the control unit performs control so that the specified processing is not re-executed.

4. The wireless communication device according to claim 2, wherein the control unit controls an operation of a controlled device mounted in a moving object on the basis of a result of the authentication and a result of the specified processing.

5. The wireless communication device according to claim 4, wherein, in a case where the first wireless communication unit is caused to retransmit the authentication request, the control unit controls the operation of the controlled device on the basis of the result of the specified processing obtained before the authentication request is retransmitted.

6. The wireless communication device according to claim 4, wherein the specified processing includes distance measurement for estimating a distance between the wireless communication device and the other wireless communication device.

7. The wireless communication device according to claim 6, wherein, in a case where authenticity of the other wireless communication device is recognized on the basis of the authentication response and a distance measurement value obtained by the distance measurement is within a specified range, the control unit causes the controlled device to execute a specified operation.

8. The wireless communication device according to claim 4, wherein the wireless communication device is mounted in the moving object, and
the other wireless communication device is carried by a user who uses the moving object.

9. The wireless communication device according to claim 1, wherein the other wireless communication device is mounted in a moving object, and
the wireless communication device is carried by a user who uses the moving object.

10. The wireless communication device according to claim 1, wherein the second communication standard includes ultra-wide band radio.

11. A non-transitory computer readable storage medium having a program stored therein, the program causing a computer to realize a control function of controlling a first wireless communication unit configured to transmit and receive a wireless signal compliant with a first communication standard to and from another wireless communication device and a second wireless communication unit configured to transmit and receive a wireless signal compliant with a second communication standard different from the first communication standard to and from the other wireless communication device,
wherein, in a case where the first wireless communication unit is caused to transmit an authentication request used for authentication of the other wireless communication unit and then the first wireless communication unit is not able to receive an authentication response as a response to the authentication request from the other wireless communication device within a specified time, the control function causes the first wireless communication unit to retransmit the authentication request after transmission and reception of the wireless signal compliant with the second communication standard between the second wireless communication unit and the other wireless communication device are completed.

12. A system comprising:
a first wireless communication device; and
a second wireless communication device,
wherein the first wireless communication device includes
a first wireless communication unit configured to transmit and receive a wireless signal compliant with a first communication standard to and from the second wireless communication device,
a second wireless communication unit configured to transmit and receive a wireless signal compliant with a second communication standard different from the first communication standard to and from the second wireless communication device, and
a control unit configured to control transmission and reception of wireless signals of the first wireless communication unit and the second wireless communication unit, and
wherein, in a case where the first wireless communication unit is caused to transmit an authentication request used for authentication of the second wireless communication unit and then the first wireless communication unit is not able to receive an authentication response as a response to the authentication request from the second wireless communication device within a specified time, the control unit causes the first wireless communication unit to retransmit the authentication request after transmission and reception of the wireless signal compliant with the second communication standard between the second wireless communication unit and the second wireless communication device are completed.
